(19) United States
(12) Patent Application Publication
(10) Pub. No.: US 2025/0177088 A1
(43) Pub. Date: Jun. 5, 2025

(54) DENTAL BUR

(71) Applicant: DENFLEX CO., LTD, Seoul (KR)

(72) Inventor: Hyung Woo KIM, Goyang (KR)

(21) Appl. No.: 17/997,050

(22) PCT Filed: Oct. 17, 2022
(86) PCT No.: PCT/KR2022/015735

§ 371 Date: Feb. 2, 2025

(30) Foreign Application Priority Data
Jan. 10, 2022 (KR) 10-2022-0003226

(51) Int. Cl. A61C 3/02

(52) U.S. Cl. CPC A61C 3/02

(57) ABSTRACT

Proposed is a dental bur. A bur shank configured to be fastened to a bur holder of a handpiece is provided with a longitudinal axial hole formed along a predetermined portion of the length of the bur shank to extend in the direction of the longitudinal center axis of the bur shank. The cross-sectional area of the dental bur is reduced to be smaller than the cross-sectional area of a related-art dental bur having a cylindrical shape so as to reduce the overall weight of the dental bur, thereby increasing the number of revolutions of the dental bur and improving the cutting performance of the dental bur.

### CROSS REFERENCE TO RELATED APPLICATIONS

This application is a 371 of international application PCT/KR2022/015735 filed Oct. 17, 2022, and is related to and claims priority from Korean Patent Application No. 10-2022-0003226 filed Jan. 10, 2022, which is incorporated herein by reference in its entirety.

### TECHNICAL FIELD

The present disclosure relates to a dental bur and, more particularly, to a dental bur configured such that a bur shank configured to be fastened to a bur holder of a handpiece is provided with a longitudinal axial hole formed along a predetermined portion of the length of the bur shank to extend in the direction of the longitudinal center axis of the bur shank. The cross-sectional area of the dental bur may be reduced to be smaller than the cross-sectional area of a related-art dental bur having a cylindrical shape so as to reduce the overall weight of the dental bur, thereby increasing the number of revolutions of the dental bur and improving the cutting performance of the dental bur. Furthermore, a higher number of revolutions of the dental bur may be obtained and thus the necessity of applying excessive pressure to the handpiece may be removed, thereby increasing the lifetime of the handpiece.

### BACKGROUND ART

In general, a dental bur is a tool configured to be coupled to a bur holder of a handpiece. The dental bur is rotated by the handpiece that generates rotational force from air pressure so as to cut an object in contact therewith in an oral cavity.

The bur holder of the handpiece is configured to hold and surround the outer surface of the dental bur. In particular, the bur holder is configured to apply a predetermined level of pressure to the outer surface of the dental bur toward the vertical center axis of the dental bur so as to prevent the dental bur from being dislodged from the bur holder.

Referring to the operating principle of the handpiece rotating the dental bur, the handpiece is configured such that an impeller (i.e., rotor blades) is provided outside the bur holder and, when strong air pressure is applied to the impeller, strong rotational force may be transmitted to the dental bur directly or indirectly coupled to the impeller. Thus, the number of revolutions of the dental bur in the same air pressure is affected by the weight of the dental bur. That is, in the same air pressure, the heavier the dental bur, the smaller the number of revolutions of the dental bur may be.

For these reasons, a smaller handpiece convenient to use within a narrow oral cavity has relatively weak rotational force, since blades thereof subjected air pressure have a smaller size. In this case, when an existing dental bur is used, the rotating speed and the cutting force of the dental bur are significantly smaller than those of a dental bar used in a larger handpiece having a larger blade size. As a result, a longer time is consumed for the cutting, thereby increasing patient inconvenience and an operation time.

In addition, a user sometimes applies pressure in the cutting direction in order to compensate for the reduced cutting force. When such excessive pressure is applied, friction between the contact surface of the bur holder of the handpiece and a bur shank is increased. Consequently, the inner surface of the bur holder may be worn, or fusion may occur between the contact surfaces of the bur holder of the handpiece and the bur shank. In addition, bearings used in the handpiece may also be overloaded, thereby reducing the lifetime of the expensive handpiece.

Due to the above-described problems, in place of smaller handpieces convenient to use in a narrow oral cavity, larger handpieces having stronger rotational force while being inconvenient to use in a narrow oral cavity are generally used at present.

FIG. 1 is a perspective view illustrating a state in which a dental bur 2 is fastened to a handpiece 1 according to the related art, and FIG. 2 is a perspective view illustrating the shape of the dental bur 2 of the related art. Referring to FIG. 2, the dental bur 2 of the related art includes a bur shank 2a configured to be fastened to the handpiece and a cutting head 2b cutting an object in an oral cavity. In particular, the bur shank 2a is in the shape of a solid cylinder having a uniform diameter. Since the above-described dental bur of the related art is heavy, the rotating speed thereof is reduced, thereby lowering cutting performance. As a result, there is problem in that the use of smaller handpieces convenient to use in a narrow oral cavity is avoided.

The foregoing is intended merely to aid in the understanding of the background of the present disclosure, and is not intended to mean that the present disclosure falls within the purview of the related art that is already known to those skilled in the art.

### DISCLOSURE

### Technical Problem

Accordingly, the present disclosure has been made keeping in mind the above problems occurring in the related art, and the present disclosure is intended to propose a dental bur and, more particularly, to a dental bur configured such that a bur shank configured to be fastened to a bur holder of a handpiece is provided with a longitudinal axial hole formed along a predetermined portion of the length of the bur shank to extend in the direction of the longitudinal center axis of the bur shank. The cross-sectional area of the dental bur may be reduced to be smaller than the cross-sectional area of a related-art dental bur having a cylindrical shape so as to reduce the overall weight of the dental bur, thereby increasing the number of revolutions of the dental bur and improving the cutting performance of the dental bur. Furthermore, a higher number of revolutions of the dental bur may be obtained and thus the necessity of applying excessive pressure to the handpiece may be removed, thereby increasing the lifetime of the handpiece.

The present disclosure is also intended to propose a dental bur configured such that penetrating open areas, through-holes, or open cut portions are formed between the outer surface of the bur shank and the longitudinal axial hole. Due to this configuration, the elasticity of the bur shank may be increased. As a result, when a lateral pressure is applied to the cutting head of the dental bur, the bur shank itself may reduce or remove the lateral pressure so as to reduce the lateral pressure transmitted toward the handpiece, thereby increasing the lifetime of the handpiece.

The present disclosure is also intended to propose a dental bur configured to be convenient to use in a narrow oral cavity, thereby obtaining a sufficient amount of cutting force.

### Technical Solution

In order to achieve at least one of the above objectives, according to one aspect of the present disclosure, there is provided a dental bur rotatably mounted on a handpiece serving as a dental rotary tool, the dental bur including: a cutting head cutting an object in an oral cavity; and a bur shank inserted into and detachably fastened to a bur holder of the handpiece. The bur shank may have a longitudinal axial hole formed along a predetermined portion of the length of the bur shank to extend in a direction of a longitudinal center axis of the bur shank. The other end of the longitudinal axial hole facing toward the cutting head may be closed.

### Advantageous Effects

According to the present disclosure, the following effects are provided.

First, since the longitudinal axial hole is formed along the longitudinal center axis of the bur shank, the cross-sectional area of the bur shank may be reduced to be smaller than the cross-sectional area of a cylindrical bur shank of a dental bur of the related art so as to reduce the overall weight of the dental bur. Consequently, the number of revolutions of the dental bur may be increased without a change in fastening force for the dental bur, thereby improving the cutting performance of the dental bur.

Second, since the dental bur has a higher number of revolutions, an operator is not required to apply excessive force to the handpiece, thereby increasing the lifetime of the handpiece.

Third, the penetrating open areas, the through-holes, or the open cut portions are formed between the outer surface of the bur shank and the longitudinal axial hole. Due to this configuration, the elasticity of the bur shank may be increased. As a result, when a lateral pressure is applied to the cutting head of the dental bur, the bur shank itself may reduce or remove the lateral pressure so as to reduce the lateral pressure transmitted toward the handpiece, thereby increasing the lifetime of the handpiece.

Fourth, the use of a smaller handpiece may provide superior cutting performance, thereby improving the convenience of the operator.

### DESCRIPTION OF DRAWINGS

FIG. 1 is a perspective view illustrating a state in which a dental bur is fastened to a handpiece according to the related art;

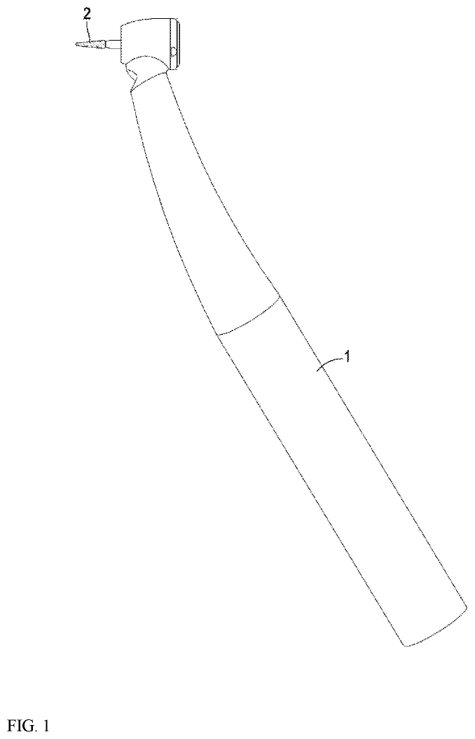

FIG. 2 is a perspective view illustrating a typical shape of the dental bur of the related art;

FIG. 3 is a perspective view illustrating a dental bur according to an embodiment of the present disclosure and a cross-sectional view taken along the line A-A of the dental bur; and

FIG. 4 is a perspective view illustrating a dental bur according to another embodiment of the present disclosure and a cross-sectional view taken along the line A-A of the dental bur.

### MODE FOR INVENTION

Hereinafter, exemplary embodiments of the present disclosure will be described in more detail with reference to the drawings.

A dental bur 100 according to the present disclosure is a cutting tool configured to be mounted on a handpiece, a rotary tool, to be rotated by the handpiece so as to cut an object in an oral cavity.

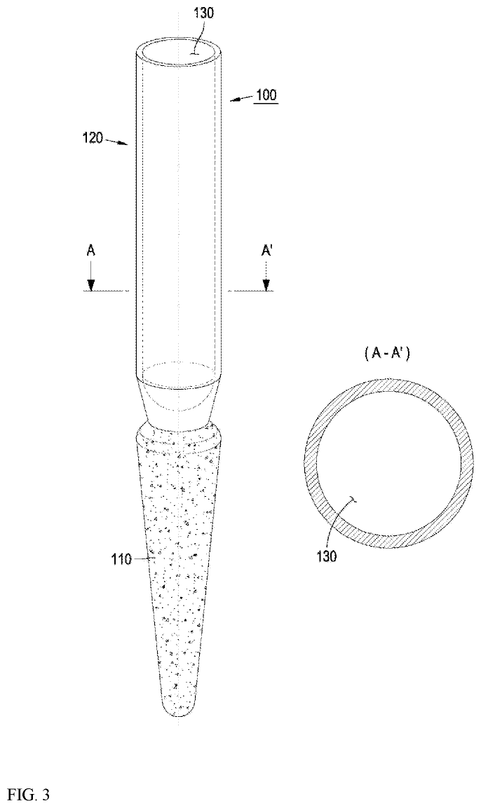

FIG. 3 is a perspective view illustrating a dental bur according to an embodiment of the present disclosure and a cross-sectional view taken along the line A-A of the dental bur.

Referring to FIG. 3, the dental bur 100 according to an embodiment of the present disclosure includes a cutting head 110 configured to cut an object in the oral cavity and a bur shank 120 configured to be inserted into and detachably fastened to a bur holder of a handpiece.

The cutting head 110 is configured to cut an object in the oral cavity. The cutting head 110 may have diamond particles electrodeposited thereon.

In particular, the bur shank 120 is provided with a longitudinal axial hole 130 formed along a predetermined portion of the length of the bur shank 120 to extend in the direction of the longitudinal center axis of the bur shank 120. Since the longitudinal axial hole 130 is formed along the longitudinal axis of the bur shank 120 in this manner, the volume of the dental bur 100 may be smaller than the volume of the cylindrical dental bur of the related art by the volume of the longitudinal axial hole 130. Thus, cutting force may be increased by increasing the number of revolutions of the dental bur without changing bur fastening force between the bur holder of the handpiece and the outer surface of the bur shank. The bur shank may be configured such that the top end portion thereof is symmetrical in the transverse direction when viewed from above. Particularly, the longitudinal axial hole may be configured such that the other end thereof facing the cutting head is closed. More particularly, the longitudinal axial hole may be configured such that the diameter thereof varies according to the longitudinal position.

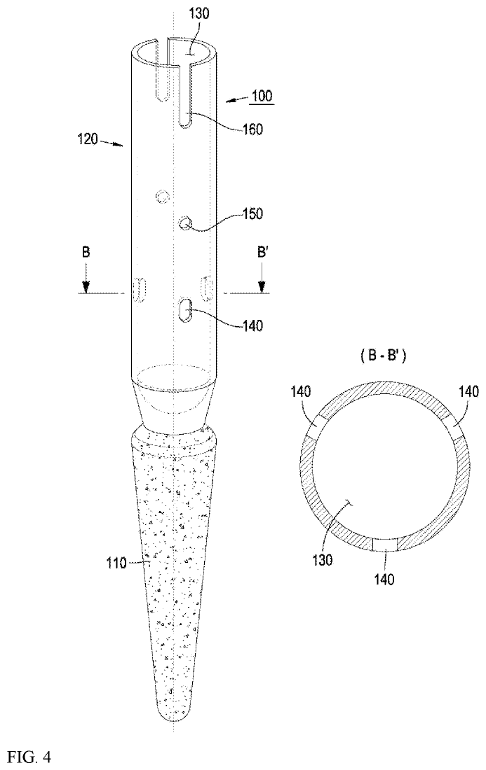

FIG. 4 is a perspective view illustrating a dental bur according to another embodiment of the present disclosure and a cross-sectional view taken along the line A-A of the dental bur.

Referring to FIG. 4, one or more penetrating open areas 140 or one or more through-holes 150 connecting the longitudinal axial hole 130 and the bur shank 120 may be provided. In addition, one or more open cut portions 160 extending from an outermost entrance of the longitudinal axial hole 130 toward the cutting head may be formed.

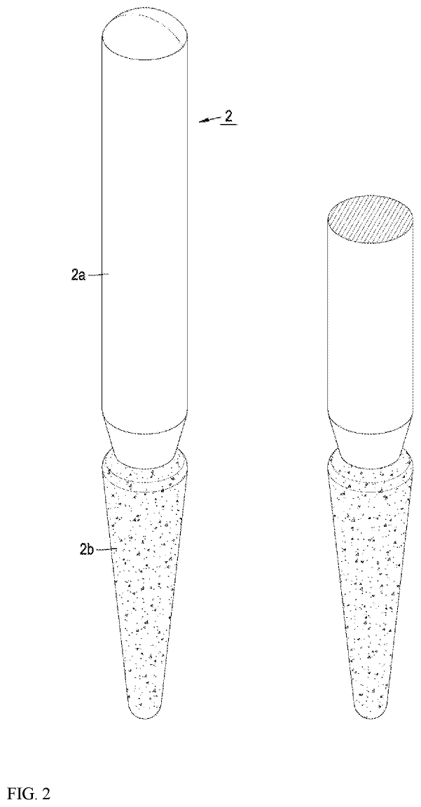

Particularly, a plurality of penetrating open areas 140, a plurality of through-holes 150, and a plurality of open cut portions 160 are formed. In a situation in which the plurality of open areas, the plurality of through-holes, and the plurality of cut portions are formed, the open areas, the through-holes, and the cut portions are formed such that the open areas, the through-holes, and the cut portions are symmetrical about the longitudinal axis or that an angle defined between the longitudinal axis and a line connecting the centers of the penetrating open areas 140, the through-holes 150, or the open cut portions 160 is the same when viewed on the cross-sectional surface. For example, as illustrated on the B-B cross-section in FIG. 2, three penetrating open areas 140 are formed at every 120° along the outer circumference of the bur shank 120. According to this configuration, the weight of the dental bur is uniformly distributed along the outer circumference about the longitudinal axis of rotation, in particular, in order to prevent vibration or the like during high-speed rotation.

As set forth above, the forming of the penetrating open areas 140, the through-holes 150, or the open cut portions 160 between the longitudinal axial hole 130 and the outer surface of the bur shank 120 may increase the elasticity of the bur shank due to the structural characteristics of the penetrating open areas 140, the through-holes 150, or the open cut portions 160. Consequently, when a lateral pressure is applied to the cutting head 110 during an operation, the bur shank itself may reduce or remove the lateral pressure so as to reduce the lateral pressure transmitted toward the handpiece, thereby increasing the lifetime of the handpiece.

Although the exemplary embodiments of the present disclosure have been described in detail with reference to the accompanying drawings, the present disclosure is not limited to such specific structures. Those skilled in the art will appreciate that various modifications or alterations are possible without departing from the scope and spirit of the present disclosure as disclosed in the accompanying claims. It should be understood, however, that such simple changes in design materials or modified structures will fall within the scope of the present disclosure.

1. A dental bur rotatably mounted on a handpiece serving as a dental rotary tool, the dental bur comprising:
a cutting head cutting an object in an oral cavity; and
a bur shank inserted into and detachably fastened to a bur holder of the handpiece,
wherein the bur shank has a longitudinal axial hole formed along a predetermined portion of the length of the bur shank to extend in a direction of a longitudinal center axis of the bur shank, with the other end of the longitudinal axial hole facing toward the cutting head being closed.

2. The dental bur of claim 1, wherein the diameter of the longitudinal axial hole varies according to a longitudinal position.

3. The dental bur of claim 1, wherein one or more penetrating open areas or one or more through-holes are provided to connect the longitudinal axial hole and an outer surface of the bur shank.

4. The dental bur of claim 1, wherein one or more open cut portions are provided to extend in a direction from an outermost entrance portion of the longitudinal axial hole toward the cutting head.

5. The dental bur of claim 3, wherein, when the open areas are a plurality of open areas, or the through-holes are a plurality of through-holes, the open areas or the through-holes are symmetrical about the longitudinal axis, or an angle defined between the longitudinal axis and a line connecting centers of the penetrating open areas or the through-holes is the same when viewed on a cross-section.

6. The dental bur of claim 4, wherein, when the cut portions are a plurality of cut portions, the cut portions are symmetrical about the longitudinal axis, or an angle defined between the longitudinal axis and a line connecting centers of the open cut portions is the same when viewed on a cross-section.

7. The dental bur of claim 1, wherein a top end portion of the bur shank is symmetrical in a transverse direction when viewed from above.

8. The dental bur of claim 1, wherein the cutting head comprises diamond particles electrodeposited thereon.
